(19) United States
(12) Patent Application Publication
(10) Pub. No.: US 2006/0033072 A1
(43) Pub. Date: Feb. 16, 2006

(54) Stabilized trifluoroiodomethane compositions

(75) Inventors: David P. Wilson, East Amherst, NY (US); Raymond H. Thomas, Pendelton, NY (US); Rajiv R. Singh, Getzville, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/109,575

(22) Filed: Apr. 18, 2005

Related U.S. Application Data
(63) Continuation-in-part of application No. 10/826,811, filed on Apr. 16, 2004.
(63) Continuation-in-part of application No. 10/826,072, filed on Apr. 16, 2004.
(63) Continuation-in-part of application No. 10/826,727, filed on Apr. 16, 2004.
(63) Continuation-in-part of application No. 10/826,592, filed on Apr. 16, 2004, now Pat. No. 6,969,701.
(63) Continuation-in-part of application No. 10/826,597, filed on Apr. 16, 2004.
(60) Provisional application No. 60/563,085, filed on Apr. 16, 2004.

(51) Int. Cl. C09K 5/04

(52) U.S. Cl. 252/67

(57) ABSTRACT

Provided are novel compositions comprising trifluoroiodomethane and an effective amount of a stabilizer preferably comprising at least one phenol compound and optionally at least one epoxide selected from the group consisting of aromatic epoxides, alkyl epoxides, alkenyl epoxides, multisubstituted epoxides, and combinations of two or more thereof. Also provided are methods of stabilizing a composition comprising trifluoroiodomethane by providing a composition comprising trifluoroiodomethane and introducing to the provided composition an effective amount of a stabilizer comprising at least one phenol compound and optionally at least one epoxide selected from the group consisting of aromatic epoxides, alkyl epoxides, alkenyl epoxides, and combinations of two or more thereof.

### CROSS-REFERENCES TO RELATED APPLICATIONS

The present application is a Continuation in Part of each of U.S. application Ser. Nos. 10/826,811, 10/826,072, 10/826,727, 10/826,592 and 10/826,597, all of which were filed on Apr. 16, 2004. The present application is also related to and claims the priority benefit of U.S. Provisional Patent Application Ser. No. 60/563,085 filed Apr. 16, 2004. The disclosures of all six applications are incorporated herein by reference.

Also incorporated herein by reference are the following U.S. Applications identified by Attorney Docket Nos. H0007522-4510 CIP; H0005706-4510 CIP; H0005518-4510 CIP; H0005517-4510 CIP, and H0007523-4510 CIP, each of which is filed concurrently herewith.

### BACKGROUND

Halogenated hydrocarbons have found widespread use in a variety of industrial applications, including as refrigerants, aerosol propellants, blowing agents, heat transfer media, gaseous dielectrics, and the like. Because of the suspected environmental problems associated with the use of halogenated hydrocarbon fluids, such as chlorofluorocarbons (“CFCs”), some hydrochlorofluorocarbons (“HCFCs”), and some hydrofluorocarbons (“HFCs”) which tend to exhibit relatively high global warming potentials, it is desirable to use fluids having lower global warming potentials as replacements for these fluids and other disfavored halogenated compounds.

Applicants have recognized that certain compositions comprising iodinated compounds, and in particular, compositions comprising trifluoroiodomethane, may be used advantageously to replace various chlorinated compounds in refrigeration (and other) applications to reduce potential environmental damage caused thereby. Applicants have further recognized, however, that iodinated compounds such as trifluoroiodomethane tend to be relatively unstable, and often significantly less stable, than CFCs, HCFCs and HFCs under certain conventional refrigeration conditions. For example, while performing standard, recommended ASHRAE and SAE testing on various refrigerants, applicants discovered that compounds comprising trifluoroiodomethane produced the brown/black color of iodine, formed from the degradation of the trifluoroiodomethane during the testing conditions, while various CFCs, HCFCs and HFCs tended to be sufficiently stable under such conditions.

To be useful as refrigerants and replacements for other CFC, HCFC and HFC fluids, suitable compositions comprising iodinated compounds must be stabilized. Applicants have recognized one possible way to produce suitable stable iodo-compositions is to use stabilizing compounds therein.

A variety of stabilizers for use with HCFC and CFC compositions are known. HFCs, due to their exceptional stability, may or may not use stabilizers incorporated in their compositions as known in the art. For example, U.S. Pat. No. 5,380,449 discloses compositions comprising dichlorotrifluoroethane and stabilizing amounts of at least one phenol and at least one aromatic or fluorinated alkyl epoxide. However, because iodo-compounds tend to be significantly less stable that CFCs and HCFCs, it cannot be predicted from teachings of stabilizers for CFCs and HCFCs (e.g. the '449 disclosure) whether the same or similar compounds are capable of stabilizing iodo-compounds to a sufficient degree for use as CFC/HCFC replacements. That is, as will be recognized by those of skill in the art, C—Cl and C—F bonds tend to be at least about 1.5-2 times stronger than C—I bonds. Accordingly, it is not inherent or necessarily reasonable to expect that a compound that stabilizes an HCFC or CFC will be suitable for an iodo-compound which requires about twice the amount of added stability to be useful in refrigerant applications.

Applicants have thus recognized the need to produce compositions comprising iodo-compounds, such as trifluoroiodomethane, that are sufficiently stable for a variety of uses including as replacements for CFC, HCFC and HFC refrigerants.

### SUMMARY OF THE INVENTION

The present invention provides a variety of compositions comprising trifluoroiodomethane (CF₃I) that are surprisingly stable and can be used advantageously in a variety of applications, including as refrigerants in various cooling systems. In particular, applicants have discovered unexpectedly that trifluoroiodomethane can be combined with a variety of one or more stabilizer compounds to produce a stabilized trifluoroiodomethane composition suitable for industrial use. In addition, not only are the present compositions sufficiently stable for a variety of uses, but also, they tend to exhibit a unique combination of non-flammability and low combined ozone-depletion and global warming properties, making them particularly useful candidates as CFC, HCFC, and HFC refrigerant replacements.

Accordingly, in one aspect of the present invention, provided are compositions comprising trifluoroiodomethane (CF₃I) and an effective amount of a stabilizer, preferably comprising at least one phenol compound and/or at least one epoxide, preferably selected from the group consisting of aromatic epoxides and fluorinated alkyl epoxides.

Applicants have further recognized that the present compositions are stable in, and suitable for use in refrigeration and other applications with, a variety of conventional lubricants. Therefore, according to another aspect of the present invention is provided a composition comprising CF₃I, an effective amount of a stabilizer of the present invention, and a lubricant.

According to yet another aspect of the present invention is provided a method of stabilizing a composition comprising CF₃I, the method comprising providing a composition comprising CF₃I and introducing to the composition comprising CF₃I an effective amount of a stabilizer of the present invention.

### DESCRIPTION OF THE PREFERRED EMBODIMENTS

The present invention provides a composition comprising trifluoroiodomethane and an effective amount of a stabilizer preferably comprising at least one phenol compound and/or at least one epoxide selected from the group consisting aromatic epoxides, alkyl epoxides, alkenyl epoxides and combinations of two or more thereof.

Trifluoroiodomethane from any suitable source may be used in the compositions of the present invention. For example, commercially available trifluoroiodomethane, available from a variety of sources including Matheson TriGas, Inc. and F-Tech may be used. In addition, trifluoroiodomethane prepared via any of a variety of conventional methods may be used. An example of one such conventional method of preparing trifluoroiodomethane is disclosed in “The Degradation of Silver Trifluoroacetate to Trifluoroiodomethane” by A. L. Henne and W. G. Finnegan, J. Am. Chem. Soc. 72, 3806 (1950), which is incorporated herein by reference.

Any of a variety of phenol compounds is suitable for use in the present compositions. While applicants do not wish to be bound by or to any theory of operation, it is believed that the present phenols act as radical scavengers in the CF₃I compositions and thereby tend to increase the stability of such compositions. As used herein the term “phenol compound” refers generally to any substituted or unsubstituted phenol. Examples of suitable phenol compounds include phenols comprising one or more substituted or unsubstituted cyclic, straight-chain, or branched aliphatic substituent group, such as, alkylated monophenols including: 2,6-di-tert-butyl-4-methylphenol; 2,6-di-tert-butyl-4-ethylphenol; 2,4-dimethyl-6-tert-butylphenol; tocopherol; and the like, hydroquinone and alkylated hydroquinones including: t-butyl hydroquinone; other derivatives of hydroquinone; and the like, hydroxylated thiodiphenyl ethers including: 4,4′-thiobis (2-methyl-6-tert-butylphenol); 4,4′-thiobis (3-methyl-6-tert-butylphenol); 2,2′-thiobis (4-methyl-6-tert-butylphenol); and the like, alkylidene-bisphenols including: 4,4′-methylenebis(2,6-di-tert-butylphenol); 4,4′-bis(2,6-di-tert-butylphenol; derivatives of 2,2- or 4,4-biphenyldiols; 2,2′-methylenebis(4-ethyl-6-tertbutylphenol); 2,2′-methylenebis(4-methyl-6-tert-butylphenol); 4,4,-butylidenebis(3-methyl-6-tert-butylphenol); 4,4,-isopropylidenebis(2,6-di-tert-butylphenol); 2,2′-methylenebis(4-methyl-6-nonylphenol); 2,2′-isobutylidenebis(4,6-dimethylphenol); 2,2′-methylenebis(4-methyl-6-cyclohexylphenol), 2,2- or 4,4-biphenyldiols including 2,2′-methylenebis(4-ethyl-6-tertbutylphenol), butylated hydroxy toluene (BHT), bisphenols comprising heteroatoms including: 2,6-di-tert-.alpha.-dimethylamino-p-cresol; 4,4-thiobis(6-tert-butyl-m-cresol); and the like; acylaminophenols; 2,6-di-tert-butyl-4(N,N′-dimethylaminomethylphenol); sulfides including: bis(3-methyl-4-hydroxy-5-tert-butylbenzyl) sulfide; bis(3,5-di-tert-butyl-4-hydroxybenzyl)sulfide; and the like; as well as, phenolic UV and light stabilizers, such as those disclosed in European Patent Application EP 0826675 (a copy of which is attached hereto and incorporated by reference). Certain preferred phenols include alkylated monophenols such as tocopherol, BHT, hydroquinones, and the like. Certain particularly preferred phenols include tocopherol, and the like. Most phenols are commercially available. A single phenol compound and/or mixtures of two or more phenols may be used in the present compositions.

Any of a variety of epoxides is suitable for use in the compositions of the present invention. While applicants do not wish to be bound by or to any theory of operation, it is believed that the epoxides of the present invention act as acid scavengers in the CF₃I compositions and thereby tend to increase the stability of such compositions. A single aromatic epoxide and/or mixtures of two or more aromatic epoxides may be used in the present compositions.

Examples of suitable aromatic epoxides include those defined by the formula I below: 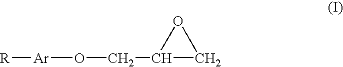
wherein: R is hydrogen, hydroxyl, alkyl, fluoroalkyl, aryl, fluoroaryl, or 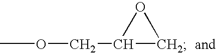
Ar is a substituted or unsubstituted phenylene or napthylene moiety. Certain preferred aromatic epoxides of Formula I include those wherein Ar is phenylene or phenylene substituted with one or more substituents including alkyls, alkenyls, alkynyls, aryls, alkylaryls, halogens, halogenated alkyls, halogenated alkenyls, halogenated alkynyls, halogenated aryls, halogenated arylalkyls, hydroxyls, heteroatom moieties, and the like. Examples of suitable compounds of Formula I wherein Ar is an unsubstituted or substituted phenylene include butylphenylglycidyl ether; pentylphenylglycidyl ether; hexylphenylglycidyl ether; heptylphenylglycidyl ether; octylphenylglycidyl ether; nonylphenylglycidyl ether; decylphenylglycidyl ether; glycidyl methyl phenyl ether; 1,4-diglycidyl phenyl diether; 4-methoxyphenyl glycidyl ether; derivatives thereof; and the like.

Certain other preferred aromatic epoxides of Formula I include those wherein Ar is napthylene or napthylene substituted with one or more substituents including alkyls, alkenyls, alkynyls, aryls, alkylaryls, halogens, halogenated alkyls, halogenated alkenyls, halogenated alkynyls, halogenated aryls, halogenated arylalkyls, hydroxyls, heteroatom moieties, and the like. Examples of suitable compounds of Formula I wherein Ar is an unsubstituted or substituted napthylene include naphthyl glycidyl ether; 1,4-diglycidyl naphthyl diether; derivatives thereof; and the like.

Examples of other suitable aromatic epoxides include bisoxiranes, such as, 2,2′[[[5-heptadecafluorooctyl]1,3phenylene]bis[[2,2,2trifluoromethyl] ethylidene]oxymethylene] bisoxirane; and the like.

In certain preferred embodiments, the aromatic epoxides for use in the present invention comprise an epoxide of Formula I wherein Ar is phenylene, substituted phenylene, napthylene, or substituted napthylene. More preferably, the aromatic epoxides comprise an epoxide of Formula I wherein Ar is phenylene or substituted phenylene. Examples of certain more preferred aromatic epoxides include butylphenyl glycidyl ether, and the like.

Any of a variety of alkyl and/or alkenyl epoxides is suitable for use in the present compositions. Examples of suitable alkyl and alkenyl epoxides include those of Formula II: 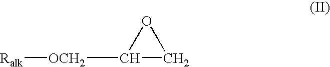
wherein Rₐₗₖ is a substituted or unsubstituted alkyl or alkenyl group. Certain preferred epoxides of Formula II comprise alkyl epoxide compounds wherein Rₐₗₖ is an alkyl group having from about 1 to about 10 carbon atoms, more preferably from about 1 to about 6 carbon atoms, and wherein the alkyl may be unsubstituted or further substituted with one or more substituents including alkyls, alkenyls, alkynyls, aryls, alkylaryls, halogens, halogenated alkyls, halogenated alkenyls, halogenated alkynyls, halogenated aryls, halogenated arylalkyls, hydroxyls, heteroatom moieties, and the like. Examples of such preferred alkyl epoxides of Formula II include n-butyl glycidyl ether, isobutyl glycidyl ether, hexanediol diglycidyl ether, and the like, as well as, fluorinated and perfluorinated alkyl epoxides, and the like. Certain more preferred alkyl epoxides comprise hexanediol diglycidyl ether, and the like.

Certain other preferred epoxides of Formula II comprise alkenyl epoxide compounds wherein Rₐₗₖ is an alkenyl group having from about 1 to about 10 carbon atoms, more preferably from about 1 to about 6 carbon atoms, and wherein the alkenyl may be unsubstituted or further substituted with one or more substituents including alkyls, alkenyls, alkynyls, aryls, alkylaryls, halogens, halogenated alkyls, halogenated alkenyls, halogenated alkynyls, halogenated aryls, halogenated arylalkyls, hydroxyls, heteroatom moieties, and the like. Examples of such preferred alkenyl epoxides of Formula II include allyl glycidyl ether, fluorinated and perfluorinated alkenyl epoxides, and the like. More preferred alkenyl epoxides include allyl glycidyl ether, and the like. A single alkyl epoxide or alkenyl epoxide and/or combinations of two or more thereof may be used in the present compositions.

In certain other preferred embodiments, the alkyl epoxide for use as an acid scavenger in the present composition comprises polypropylene glycol diglycidyl ether. Examples of polypropylene glycol diglycidyl ether suitable for use in the present invention includes the ether available commercially from SACHEM, Europe.

In addition, in certain embodiments, the epoxide for use in the present invention comprises combinations of two or more aromatic, alkyl, and/or alkenyl substituents. Such epoxides are referred to generally as “multisubstituted epoxides.”

According to certain preferred embodiments, the stabilizer for use in the present invention comprises a combination of at least one phenol compound and at least one aromatic, alkyl, or alkenyl epoxide. Examples of suitable combinations include stabilizers comprising: tocopherol and allyl glycidyl ether, BHT and glycidyl butyl ether, and the like. Certain particularly preferred combinations include stabilizers comprising: tocopherol and allyl glycidyl ether, and the like.

Any suitable relative amount of the at least one phenol compound and/or the at least one aromatic, alkyl, or alkenyl epoxide may be used in the preferred stabilizers. In certain preferred embodiments, both phenol and epoxide compound are present, with the weight ratio of phenol compound(s) to aromatic or fluorinated alkyl epoxide(s) ranging preferably from about 1:99 to about 99:1. In certain preferred embodiments, the weight ratios of phenol compound(s) to aromatic, alkyl, alkenyl, multisubstituted, or fluorinated alkyl epoxide(s) is from about 30:1 to about 1:1, more preferably from about 7:1 to about 1:1, more preferably from about 2:1 to about 1:1, and even more preferably about 1:1.

Any suitable effective amount of stabilizer may be used in the trifluoroiodomethane compositions of the present invention. As used herein, the term “effective amount” refers to an amount of stabilizer of the present invention which, when added to a composition comprising trifluoroiodomethane, results in a stabilized composition wherein the trifluoroiodomethane therein degrades more slowly and/or to a lesser degree relative to the original composition, under the same, or similar, conditions. In certain preferred embodiments, an “effective amount” of stabilizer comprises an amount which, when added to a composition comprising trifluoroiodomethane, results in a stabilized composition wherein the trifluoroiodomethane therein degrades more slowly and/or to a lesser degree relative to the original composition under the conditions of at least one, or both, of the standards tests SAE J1662 (issued June 1993) and/or ASHRAE 97-1983R. In certain more preferred embodiments, an “effective amount” of stabilizer comprises an amount which, when added to a composition comprising trifluoroiodomethane, results in a composition having a stability that is at least as good as, if not better, than the stability of a comparable composition comprising dichlorodifluoromethane (R-12) in mineral oil, as measured according to at least one, or both, of the standard tests SAE J1662 (issued June 1993) and/or ASHRAE 97-1983R. Certain preferred effective amounts of stabilizer for use in the present invention comprise from about 0.001 to about 10, more preferably from about 0.01 to about 5, even more preferably from about 0.3 to about 4 weight percent, and even more preferably from about 0.3 to about 1 weight percent based on the total weight of trifluoroiodomethane in the composition of the present invention.

According to certain embodiments, the CF₃I compositions of the present invention further comprise one or more hydrofluorocarbon (HFC) and/or hydrocarbon fluids. According to certain embodiments, any combination of one or more HFCs or hydrocarbons may be added to the present compositions, provided that the resulting CF₃I compositions have a 100 year Global Warming Potential (GWP) of preferably less that about 1000, more preferably less than about 500, more preferably less than about 150, preferably less than about 50, more preferably less than about 20, and even more preferably less than about 10. Examples of suitable HFCs for use in the present compositions include: tetrafluoropropene, including HFO-1234yf and/or HFO-1234ze, isomers of pentafluoropropene (HFO-1225), 1,3,3-trifluoro-1-propene (HFO-1243zf), difluoromethane (HFC-32), 1,1-difluoroethane (HFC-152a), and the like. Certain preferred HFCs for use in the present compositions include HFO-1234yf, HFO-1234ze, HFC-32, HFC-152, combinations of HFC-152 and HFO-1234 (yf and/or ze), HFO-1225, combinations of one or more HFO-1225 isomers with HFC-152a, combinations of HFO-1225 isomers with one or more HFO-1234 isomers, and the like.

Examples of suitable hydrocarbons include hydrocarbons having from about 1 to about 20 carbon atoms, more preferably from about 1 to about 10 carbon atoms. Certain even more preferred hydrocarbons include those having from about 3 to about 6 carbon atoms, including propane, isomers of butane, combinations thereof, isomers of pentane, and the like.

In certain preferred embodiments, the compositions of the present invention further comprise a lubricant. Any of a variety of conventional and unconventional lubricants may be used in the compositions of the present invention. An important requirement for the lubricant in many preferred systems is that, when in use in a refrigerant system, there must be sufficient lubricant returning to the compressor of the system such that the compressor is lubricated. Thus, suitability of a lubricant for any given system is determined partly by the refrigerant/lubricant characteristics and partly by the characteristics of the system in which it is intended to be used. Examples of suitable lubricants, which are generally those commonly used in refrigeration machinery using or designed to use hydrofluorocarbon (HFC) refrigerants, chloroflurocarbon refrigerants and hydrochlorofluorocarbons refrigerants, include mineral oils, silicone oil, polyalkyl benzenes (sometimes referred to as PABs), polyol esters (sometimes referred to as POEs), polyalkylene glycols (sometimes referred to as PAGs), polyalkylene glycol esters (sometimes referred to as PAG esters), polyvinyl ethers (sometimes referred to as PVEs), poly(alpha-olefin) (sometimes referred to as PAOs), and the like. Mineral oil, which comprises paraffin oil or naphthenic oil, is commercially available. Commercially available mineral oils include Witco LP 250 (registered trademark) from Witco, Zerol 300 (registered trademark) from Shrieve Chemical, Sunisco 3GS from Witco, and Calumet R015 from Calumet. Commercially available polyalkyl benzene lubricants include Zerol 150 (registered trademark). Commercially available esters include neopentyl glycol dipelargonate which is available as Emery 2917 (registered trademark) and Hatcol 2370 (registered trademark). Other useful esters include phosphate esters, dibasic acid esters, and fluoroesters. Preferred lubricants include polyalkylene glycols and esters. For refrigeration systems using or designed to use HFCs, it is generally preferred to use as lubricants PAGs, PAG esters, PVEs, and POEs particularly for systems comprising vapor compression refrigeration, air-conditioning (especially for automotive air conditioning) and heat pumps. For refrigeration systems using or designed to use CFCs or HCFCs, it is generally preferred to use as lubricants mineral oil or PAB. In certain preferred embodiments, the lubricants of this invention are organic compounds which are comprised of carbon, hydrogen and oxygen with a ratio of oxygen to carbon selected to provide, in combination with the amounts used, to have effective solubility and/or miscibility with the refrigerant to ensure sufficient return of the lubricant to the compressor of the system. This solubility or miscibility preferably exists at least one temperature from about −30° C. and 70° C.

PAGs and PAG esters are highly preferred in certain embodiments because they are currently in use in particular applications such as original equipment mobile air-conditioning systems. Polyol esters are highly preferred in other certain embodiments because they are currently in use in particular non-mobile applications such as residential, commercial, and industrial air conditioning and refrigeration. Of course, different mixtures of different types of lubricants may be used.

Any of a variety of other additives may be used in the compositions of the present invention. Examples of suitable additives include metal passivators such as nitromethane, extreme pressure (EP) additives which improve the lubricity and load bearing characteristics of the lubricant, and corrosion inhibitors. Examples of suitable EP additives include organophosphates, such as Lubrizol® 8478, made by the Lubrizol corporation, and the EP additives described in U.S. Pat. No. 4,755,316 (See, for example, table D), which is incorporated herein by reference. Examples of suitable corrosion inhibitors include those also described in U.S. Pat. No. 4,755,316. Flame suppression agents may also be included.

The present invention further provides methods for stabilizing a composition comprising trifluoroiodomethane including the steps of providing a composition comprising trifluoroiodomethane and introducing to the composition an effective amount of a stabilizer comprising at least one phenol compound and at least one epoxide selected from the group consisting of aromatic epoxides, alkyl epoxides, alkenyl epoxides, and combinations of two or more thereof.

Any suitable composition comprising trifluoroiodomethane may be provided according to the present invention. Such suitable provided compositions may include, in addition to trifluoroiodomethane, any one or more of the HFC/hydrocarbon fluids, additives, or lubricants as discussed above. The provided composition may also include one or more stabilizers as detailed above, or as otherwise known in the art—provided that the stabilized composition is further capable of being stabilized according to the present methods.

Any suitable method for introducing an effective amount of stabilizer of the present invention to the provided trifluoroiodomethane composition may be used in the claimed methods. For example, the stabilizer may be introduced to the trifluoroiodomethane composition by methods comprising pouring, injecting, spraying, pipeting, adding dropwise, pumping, combinations of two or more thereof, and the like, either or both of the stabilizer or trifluoroiodomethane composition into the other of the stabilizer or trifluoroiodomethane composition.

The stabilizer of the present invention may be further mixed with another fluid prior to introducing the stabilizer to the trifluoroiodomethane composition. In such embodiments, the introducing step comprises introducing to the trifluoroiodomethane composition a fluid composition comprising the stabilizer, and optionally, further comprising any one or more of the HFC/hydrocarbon fluids, additives, or lubricants as discussed above, to be introduced to the trifluoroiodomethane composition. In certain preferred embodiments, the introducing step comprises introducing a lubricant composition, that is, a composition comprising the stabilizer and at least one lubricant, preferably an effective amount of stabilizer, to the trifluoroiodomethane composition. Any suitable lubricants may be used in the lubricant composition of the preferred introducing step of the present methods. In certain preferred embodiments, the introducing step of the present methods comprises introducing a lubricant composition comprising an effective amount of stabilizer to the trifluoroiodomethane composition.

In light of the teachings herein, those of skill in the art will be readily able to introduce an effective amount of stabilizer to a trifluoroiodomethane composition according to the present invention to produce a stabilized composition.

### EXAMPLES

The application is further explained in light of the following examples which are illustrative and not intended to be limiting in any manner.

### Example 1

This example illustrates a stabilized composition of the present invention comprising CF₃I and a stabilizer comprising tocopherol and allyl glycidyl ether.

Trifluoroiodomethane (1.6 grams) is added to 3 grams of mineral oil containing tocopherol (1 wt. % based on the total weight of the mineral oil) and allyl glycidyl epoxide (1 wt. % based on the total weight of the mineral oil). The resulting mixture is placed into a glass tube with metal coupons of aluminum, steel, and copper and the tube is sealed. The sealed glass tube is put into an oven at 300° F. for two weeks. After such time the tube is removed and observed.

Upon observation, the mixture is one phase, indicating that the refrigerant is miscible and soluble in the mineral oil. In addition, the liquid in the tube is clear with a light yellow color. The steel coupon appears unchanged.

### Example 2

This example illustrates a stabilized composition of the present invention comprising CF₃I, HFO-1234yf, and a stabilizer comprising tocopherol and allyl glycidyl ether.

A mixture of 25 wt. % trifluoroiodomethane and 75 wt. % HFO-1234yf is made and 1.6 grams of the mixture is added to 3 grams of polyalkylene glycol oil containing tocopherol (1 wt. % based on the total weight of the mineral oil) and allyl glycidyl epoxide (1 wt. % based on the total weight of the mineral oil). The resulting mixture is placed into a glass tube with metal coupons of aluminum, steel, and copper and the tube is sealed. The sealed glass tube is put into an oven at 300° F. for two weeks. After such time the tube is removed and observed.

Upon observation, the mixture is one phase, indicating that the refrigerant is miscible and soluble in the mineral oil. In addition, the liquid in the tube is clear with a light yellow color. The steel coupon appears unchanged.

### Comparative Example 1

This example illustrates a relatively unstable composition comprising CF₃I and HFO-1234yf.

A 50:50 mixture of trifluoroiodomethane and HFO-1234yf is prepared and about 3 grams of the mixture is sealed in a glass tube with an equal amount by weight of polyalkylene glycol oil. The sealed glass tube is put into an oven at 300° F. for three weeks. After removal, the contents of the tube have changed from colorless to brown, indicating decomposition of the trifluoroiodomethane refrigerant.

### Example 3

This example illustrates a stabilized composition of the present invention comprising CF₃I, HFO-1234yf, and a stabilizer comprising BHT and butyl glycidyl ether.

A mixture similar to that of comparative example 1 is prepared and placed in a sealed glass tube, except that 5 wt. % (based on the total weight of the polyalkylene glycol oil) of a 50:50 mixture of BHT and butyl glycidyl ether is added to the polyalkylene glycol lubricant. The sealed glass tube is put into an oven at 300° F. for three weeks. After removal, the contents of the tube appear relatively unchanged, indicating significant improvement in the stability thereof.

### Comparative Example 2

This example illustrates a relatively unstable composition comprising CF₃I and HFO-1234yf.

A 50:50 mixture of trifluoroiodomethane and HFO-1234yf is prepared and the mixture is sealed in a glass tube containing coupons of copper, steel, and aluminum, with an equal amount by weight of polyalkylene glycol oil. The sealed glass tube is put into an oven at 300° F. for two weeks. After removal, the contents of the tube were opaque and black, indicating severe decomposition.

### Example 4

This example illustrates a stabilized composition of the present invention comprising CF₃I, HFO-1234yf, and a stabilizer comprising BHT and butyl glycidyl ether.

A mixture similar to that of comparative example 2 is prepared and placed in a sealed glass tube containing coupons of copper, steel, and aluminum, except that 5 wt. % (based on the total weight of polyalkylene glycol oil) of a 50:50 mixture of BHT and butyl glycidyl ether is added to the polyalkylene glycol lubricant. The sealed glass tube is put into an oven at 300° F. for two weeks. After removal, the contents of the tube have changed to a light transparent brown color, indicating a significant reduction in decomposition as compared to the composition of comparative example 2.

What is claimed is:

1. A composition comprising trifluoroiodomethane and an effective amount of a stabilizer comprising at least one phenol compound.

2. The composition of claim 1 wherein said stabilizer further comprises at least one epoxide selected from the group consisting of aromatic epoxides, alkyl epoxides, alkenyl epoxides, multisubstituted epoxides, and combinations of two or more thereof.

3. The composition of claim 1 wherein said at least one phenol compound is selected from the group consisting of 4,4′-methylenebis(2,6-di-tert-butylphenol); 4,4′-bis(2,6-di-tert-butylphenol); 2,2-biphenyldiols, 4,4-biphenyldiols; derivatives of 2,2- and 4,4-biphenyldiols; 2,2′-methylenebis(4-ethyl-6-tertbutylpheol); 2,2′-methylenebis(4-methyl-6-tert-butylphenol); 4,4,-butylidenebis(3-methyl-6-tert-butylphenol); 4,4,-isopropylidenebis(2,6-di-tert-butylphenol); 2,2′-methylenebis(4-methyl-6-nonylphenol); 2,2′-isobutylidenebis(4,6-dimethylphenol); 2,2′-methylenebis(4-methyl-6-cyclohexylphenol); 2,6-di-tert-butyl-4-methylphenol; BHT; 2,6-di-tert-butyl-4-ethylphenol; 2,4-dimethyl-6-tert-butylphenol; 2,6-di-tert-.alpha.-dimethylamino-p-cresol; 2,6-di-tert-butyl-4(N,N′-dimethylaminomethylphenol); 4,4′-thiobis (2-methyl-6-tert-butylphenol); 4,4′-thiobis (3-methyl-6-tert-butylphenol); 2,2′-thiobis (4-methyl-6-tert-butylphenol); bis(3-methyl-4-hydroxy-5-tert-butylbenzyl) sulfide; bis(3,5-di-tert-butyl-4-hydroxybenzyl)sulfide; tocopherol; hydroquinone; t-butyl hydroquinone; derivatives of hydroquinone; and combinations of two or more thereof.

4. The composition of claim 3 wherein said at least one phenol comprises tocopherol.

5. The composition of claim 2 wherein said at least one epoxide comprises an aromatic epoxide defined by the formula I: 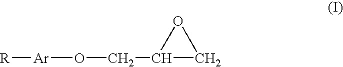
wherein: R is hydrogen, alkyl, fluoroalkyl, aryl, fluoroaryl, or 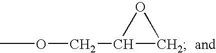
Ar is a substituted or unsubstituted phenylene or napthylene moiety.

6. The composition of claim 5 wherein said aromatic epoxide of Formula I is selected from the group consisting of butylphenylglycidyl ether; pentylphenylglycidyl ether; hexylphenylglycidyl ether; heptylphenylglycidyl ether; octylphenylglycidyl ether; nonylphenylglycidyl ether; decylphenylglycidyl ether; glycidyl methyl phenyl ether; 1,4-diglycidyl phenyl diether and derivatives thereof; 1,4-diglycidyl naphthyl diether and derivatives thereof; 2,2′[[[5-heptadecafluorooctyl]1,3phenylene]bis[[2,2,2trifluoromethyl]ethylidene]oxymethylene]bisoxirane; naphthyl glycidyl ether; 4-methoxyphenyl glycidyl ether; derivatives of naphthyl glycidyl ether; and combinations of two or more thereof.

7. The composition of claim 1 wherein said at least one epoxide comprises an alkyl or alkenyl epoxide defined by the formula II: 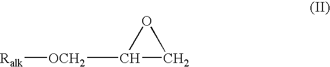
wherein Ralk is a substituted or unsubstituted alkyl or alkenyl group.

8. The composition of claim 7 wherein Ralk is a substituted alkyl, unsubstituted alkyl, substituted alkenyl, or unsubstituted alkenyl group having from about 1 to about 10 carbon atoms.

9. The composition of claim 7 wherein said epoxide of Formula II is selected from the group consisting of n-butyl glycidyl ether, isobutyl glycidyl ether, hexanediol diglycidyl ether, allyl glycidyl ether, polypropylene glycol diglycidyl ether, and combinations of two or more thereof.

10. The composition of claim 9 wherein said at least one epoxide comprises allyl glycidyl ether.

11. The composition of claim 4 wherein said at least one epoxide comprises allyl glycidyl ether.

12. The composition of claim 1 further comprising a fluid selected from the group consisting of HFCs, and combinations of two or more thereof.

13. The composition of claim 12 wherein said fluid comprises HFO-1234ze.

14. The composition of claim 12 wherein said fluid comprises HFO-1234yf.

15. The composition of claim 12 wherein said fluid comprises HFC-32.

16. The composition of claim 12 wherein said fluid comprises HFC-152a.

17. The composition of claim 12 wherein said fluid comprises at least one isomer of HFO-1225.

18. The composition of claim 1 further comprising a hydrocarbon selected from the group consisting of propane, isomers of butane, isomers of pentane, and combinations thereof.

19. The composition of claim 1 further comprising a lubricant.

20. The composition of claim 19 wherein said lubricant is selected from the group consisting of mineral oil, silicone oil, polyalkyl benzenes (PABs), polyol esters (POEs), polyalkylene glycols (PAGs), polyalkylene glycol esters (PAG esters), polyvinyl ethers (PVEs), poly(alpha-olefins) (PAOs) and combinations of two or more thereof.

21. The composition of claim 20 wherein said lubricant comprises mineral oil.

22. The composition of claim 1 further comprising an additive selected from the group consisting of metal passivators, extreme pressure additives, corrosion inhibitors, and combinations of two or more thereof.

23. A method of stabilizing a composition comprising trifluoroiodomethane comprising providing a composition comprising trifluoroiodomethane and introducing to the provided composition an effective amount of a stabilizer comprising at least one phenol compound and optionally at least one epoxide selected from the group consisting of aromatic epoxides, alkyl epoxides, alkenyl epoxides, and combinations of two or more thereof.

24. The method of claim 23 wherein said provided composition further comprises a fluid selected from the group consisting of HFCs, and combinations of two or more thereof.

25. The method of claim 24 wherein said fluid comprises HFO-1234ze.

26. The method of claim 24 wherein said fluid comprises HFO-1234yf.

27. The method of claim 24 wherein said fluid comprises HFC-32.

28. The method of claim 24 wherein said fluid comprises HFC-152a.

29. The method of claim 23 wherein said introducing step comprises introducing a lubricant comprising said effective amount of said stabilizer to said composition comprising trifluoroiodomethane.

30. The method of claim 29 wherein said lubricant is selected from the group consisting of mineral oils, silicone oil, polyalkyl benzenes (PABs), polyol esters (POEs), polyalkylene glycols (PAGs), polyalkylene glycol esters (PAG esters), polyvinyl ethers (PVEs), poly(alpha-olefins) (PAOs), and combinations of two or more of these.

31. A composition comprising trifluoroiodomethane and an effective amount of at least one stabilizer.
